(19) United States
(12) Patent Application Publication
(10) Pub. No.: US 2025/0278293 A1
(43) Pub. Date: Sep. 4, 2025

(54) Hybrid Scheduling for Heterogeneous Processor Systems

(71) Applicant: Advanced Micro Devices, Inc., Santa Clara, CA (US)

(72) Inventors: Poonam Aggrwal, Austin, TX (US); Indrani Paul, Austin, TX (US); Bharath Prabhu Perdoor, Cedar Park, TX (US)

(73) Assignee: Advanced Micro Devices, Inc., Santa Clara, CA (US)

(21) Appl. No.: 19/069,347

(22) Filed: Mar. 4, 2025

Related U.S. Application Data
(60) Provisional application No. 63/561,132, filed on Mar. 4, 2024.

(51) Int. Cl. G06F 9/48

(52) U.S. Cl. CPC G06F 9/485; G06F 9/4887

(57) ABSTRACT

Hybrid scheduling for heterogeneous processor systems is described. In one or more implementations, a system includes a central processing unit having multiple cores of at least two different core types, one or more accelerator processors, and a system management processor. The system management processor is configured to update a scheduling policy implemented by an operating system of the central processing unit from a first scheduling policy to a second scheduling policy based on a utilization of the multiple cores and/or the one or more accelerator processors. The update enables the system management processor to control task scheduling.

### RELATED APPLICATION

This application claims priority under 35 U.S.C. § 119 (e) to U.S. Provisional Patent Application No. 63/561,132, filed Mar. 4, 2024, the entire content of which is hereby incorporated by reference.

### BACKGROUND

Computing systems equipped with multiple types of processors, referred to as heterogeneous processor systems, integrate different types of processors within a single system to optimize performance, power efficiency, and functionality. In a heterogeneous processor system, individual processors (e.g., CPUs) are often equipped with different types of cores, and these processors are referred to as heterogeneous core processors. This architectural design leverages the strengths of various processors and processor cores, such as different core types of a CPU that are either optimized for performance or energy efficiency, graphics processing units (GPUs), and specialized accelerators like digital signal processors (DSPs) or neural processing units (NPUs), to handle different computational tasks effectively. The benefits of such configurations include the ability to dynamically allocate tasks to the most suitable processor and/or core type, significantly enhancing computational efficiency and speed. Another benefit is the ability to utilize energy efficient cores for workloads, tasks, and/or threads that do not require maximal performance, e.g., background tasks.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement techniques of hybrid scheduling for heterogeneous processor systems.

FIG. 3 depicts a block diagram of a non-limiting example system to transition from a first scheduling policy to a second scheduling policy.

FIG. 4 depicts a block diagram of a non-limiting example system to transition from a second scheduling policy to a first scheduling policy.

FIG. 5 depicts a procedure in an example implementation of hybrid scheduling for heterogeneous processing systems as implemented by a system management unit.

FIG. 6 depicts a procedure in an example implementation of hybrid scheduling for heterogeneous processing systems as implemented by an operating system running on a CPU.

### DETAILED DESCRIPTION

In accordance with the described techniques, a system includes a central processing unit (CPU) having multiple cores of different core types, e.g., the CPU is a heterogeneous core processor. For example, the multiple cores include one or more first-type cores and one or more second-type cores. The first-type cores exhibit increased power efficiencies when ran at reduced clock frequencies (e.g., zero to three GHz), while the second-type cores exhibit increased power efficiencies when ran at increased clock frequencies, e.g., above three GHz. That is, the first-type cores are considered energy efficient cores since running threads on the first-type cores at the reduced clock frequency reduces power consumption for the system. In contrast, the second-type cores are considered performant cores since running threads on the second-type cores at the increased clock frequency increases the speed at which the threads are executed. The system also includes one or more accelerator processors, e.g., GPUs, NPUs, video processing engines (VPEs) and the like. Broadly, the CPU is configured to run an operating system that includes a scheduler, which schedules and dispatches threads for execution by different processing resources of the system, e.g., the cores of the CPU and the accelerator processors.

In accordance with a first scheduling policy, the scheduler is configured to schedule threads based on quality of service (QOS) tags associated with the threads, which designate priorities (e.g., high priority, medium priority, low priority) associated with the threads. In addition, the scheduler is aware of a degree to which the cores of the CPU are being utilized, but is unaware of a degree to which the accelerator processors are being utilized. Generally, the scheduler prioritizes scheduling threads marked with QoS tags indicating a higher priority for execution by the second-type (e.g., performant) cores, and prioritizes scheduling threads marked with QoS tags indicating a lower priority for execution by the first-type (e.g., energy efficient) cores.

In accordance with a second scheduling policy, the scheduler is configured to schedule threads based on feedback provided by a system management unit (SMU) via a hardware feedback interface. Here, the SMU periodically reads performance counters from various hardware resources of the system, such as the cores of the CPU and the accelerator processors, which enables the firmware to calculate degrees of utilization of the cores of the CPU and/or the accelerator processors. Based on the degrees of utilization, the firmware communicates feedback to the operating system via the hardware feedback interface, which the scheduler utilizes in making scheduling decisions.

A goal of thread scheduling in a heterogeneous core CPU, like the one described, is to run lower priority threads on the first-type (e.g., energy efficient) cores to reduce power consumption for the system, while running higher priority threads on the second-type (e.g., performant) cores to increase system responsiveness while executing these threads. The first scheduling policy outperforms the second scheduling policy in achieving this goal in a large majority of utilization scenarios due to the awareness of thread-level processing demands specified by the QoS tags. However, in certain specific scenarios, the second scheduling policy outperforms the first scheduling policy in achieving this goal. These specific scenarios include when the utilization of the CPU cores is low and the utilization of the accelerator processors is high. An example of this scenario is a machine learning workload that is offloaded for execution by NPUs. In these scenarios, the workload that is running on the accelerator processors is the primary, high priority workload, while the threads running on the CPU cores are secondary, lower priority processes. Due to the lack of awareness of the accelerator-level utilization and the inaccuracy of QoS tagging schemes, the first scheduling policy often marks threads as high or medium priority threads during these utilization scenarios. This leads to the scheduler inaccurately dispatching the threads for execution by the second-type (e.g., performant) cores, which unnecessarily increases power consumption for the system.

Unlike conventional techniques, the described techniques of hybrid scheduling for heterogeneous processor systems enable a hybrid approach for thread scheduling that dynamically switches between the first scheduling policy and the second scheduling policy. By way of example, the SMU initiates an update from the first scheduling policy to the second scheduling policy responsive to detecting an accelerator dominant utilization state in which the utilization of one or more accelerator processors exceeds an accelerator utilization threshold and the utilization of the CPU cores is below a core utilization threshold. Notably, the update to the second scheduling policy causes the scheduler to use the feedback provided by the SMU via the hardware feedback interface to schedule threads, and cease using the QoS tags to make scheduling decisions. Moreover, the SMU initiates an update from the second scheduling policy to the first scheduling policy responsive to detecting an accelerator nondominant utilization state in which the utilization of the one or more accelerator processors falls below the accelerator utilization threshold and/or the utilization of the CPU cores exceeds the core utilization threshold. The update causes the scheduler to begin scheduling threads based on the QoS tags, and cease using the feedback provided via the hardware feedback interface in making scheduling decisions.

Here, the described techniques implement a hybrid scheduling approach to transition between the scheduling policies in order to implement the optimal scheduling policy for the utilization scenario. By doing so, the described techniques reduce power consumption for the system while improving or maintaining system responsiveness in executing higher priority threads, as compared to conventional techniques that implement just one scheduling policy.

In some aspects, the techniques described herein relate to a system including a central processing unit having multiple cores of at least two different core types, one or more accelerator processors, and a system management processor configured to update a scheduling policy implemented by an operating system of the central processing unit from a first scheduling policy to a second scheduling policy based on utilization of the multiple cores and/or the one or more accelerator processors, wherein the update to the second scheduling policy enables the system management processor to control task scheduling.

In some aspects, the techniques described herein relate to a system, wherein the at least two different core types exhibit different power efficiencies at different clock frequencies.

In some aspects, the techniques described herein relate to a system, wherein the first scheduling policy includes scheduling tasks based on Quality of Service tags associated with the tasks.

In some aspects, the techniques described herein relate to a system, wherein to update the scheduling policy, the system management processor is configured to generate a ranking of the multiple cores based on the utilization of the multiple cores and/or the one or more accelerator processors, and communicate the ranking to the operating system for use in scheduling tasks in accordance with the second scheduling policy.

In some aspects, the techniques described herein relate to a system, wherein the utilization of the multiple cores is below a first threshold and the utilization of the one or more accelerator processors is above a second threshold, and the ranking includes one or more cores of a first core type ranked higher than one or more cores of a second core type, wherein the first core type exhibits increased power efficiency relative to the second core type at a reduced clock frequency.

In some aspects, the techniques described herein relate to a system, wherein to communicate the ranking, the system management processor is configured to write the ranking to a first interface, write a first command type to a second interface, the first command type instructing the operating system to switch from implementing the first scheduling policy to implementing the second scheduling policy, and raise an interrupt via the second interface causing the central processing unit to read the first command type from the second interface and read the ranking from the first interface for use by the operating system in scheduling the tasks.

In some aspects, the techniques described herein relate to a system, wherein the system management processor is further configured to write an updated ranking to the first interface based on an updated utilization of the multiple cores, write a third command type to the second interface, the third command type instructing the operating system to continue implementing the second scheduling policy in accordance with the updated ranking, and raise an additional interrupt via the second interface causing the central processing unit to read the third command type from the second interface and read the updated ranking from the first interface for use by the operating system in scheduling the tasks.

In some aspects, the techniques described herein relate to a system, wherein the system management processor is configured to further update the scheduling policy from the second scheduling policy to the first scheduling policy based on an updated utilization of the multiple cores and/or the one or more accelerator processors, wherein the further update to the first scheduling policy relinquishes control by the system management processor to influence the task scheduling.

In some aspects, the techniques described herein relate to a system, wherein the updated utilization of the multiple cores is above a first threshold and the updated utilization of the one or more accelerator processors is below a second threshold.

In some aspects, the techniques described herein relate to a system, wherein to further update the scheduling policy, the system management processor is configured to write a second command type to an interface, the second command type instructing the operating system to switch from implementing the second scheduling policy to implementing the first scheduling policy, and raise an interrupt via the interface causing the central processing unit to read the second command type from the interface.

In some aspects, the techniques described herein relate to a system management processor configured to detect a utilization of one or more accelerator processors and/or multiple cores of a central processing unit, the multiple cores including at least two different core types, and update a scheduling policy of an operating system from a second scheduling policy to a first scheduling policy based on the utilization, wherein the update to the first scheduling policy relinquishes control by the system management processor to influence task scheduling.

In some aspects, the techniques described herein relate to a system management processor, wherein the at least two different core types exhibit different power efficiencies at different clock frequencies.

In some aspects, the techniques described herein relate to a system management processor, wherein the first scheduling policy includes scheduling tasks based on Quality of Service tags associated with the tasks.

In some aspects, the techniques described herein relate to a system management processor, the second scheduling policy includes scheduling tasks based on a ranking of the multiple cores generated by the system management processor and communicated to the operating system via an interface.

In some aspects, the techniques described herein relate to a system management processor, wherein the utilization of the multiple cores is above a first threshold and the utilization of the one or more accelerator processors is below a second threshold.

In some aspects, the techniques described herein relate to a system management processor, wherein to update the scheduling policy, the system management processor is configured to write a second command type to an interface, the second command type instructing the operating system to switch from implementing the second scheduling policy to implementing the first scheduling policy, and raise an interrupt via the interface causing the central processing unit to read the second command type from the interface.

In some aspects, the techniques described herein relate to a device including a system management processor, one or more accelerator processors, and a central processing unit having multiple cores of at least two different core types, the central processing unit configured to receive, from the system management processor, a command to update a scheduling policy based on utilization of the multiple cores and/or the one or more accelerator processors detected by the system management processor, and update the scheduling policy by enabling or disabling control of task scheduling by the system management processor based on the utilization.

In some aspects, the techniques described herein relate to a device, wherein the at least two different core types exhibit different power efficiencies at different clock frequencies.

In some aspects, the techniques described herein relate to a device, wherein the utilization of the multiple cores is below a first threshold and the utilization of the one or more accelerator processors is above a second threshold, and to update the scheduling policy, the central processing unit is configured to enable control of the task scheduling by the system management processor.

In some aspects, the techniques described herein relate to a device, wherein the utilization of the multiple cores is above a first threshold and the utilization of the one or more accelerator processors is below a second threshold, and to update the scheduling policy, the central processing unit is configured to disable control of the task scheduling by the system management processor.

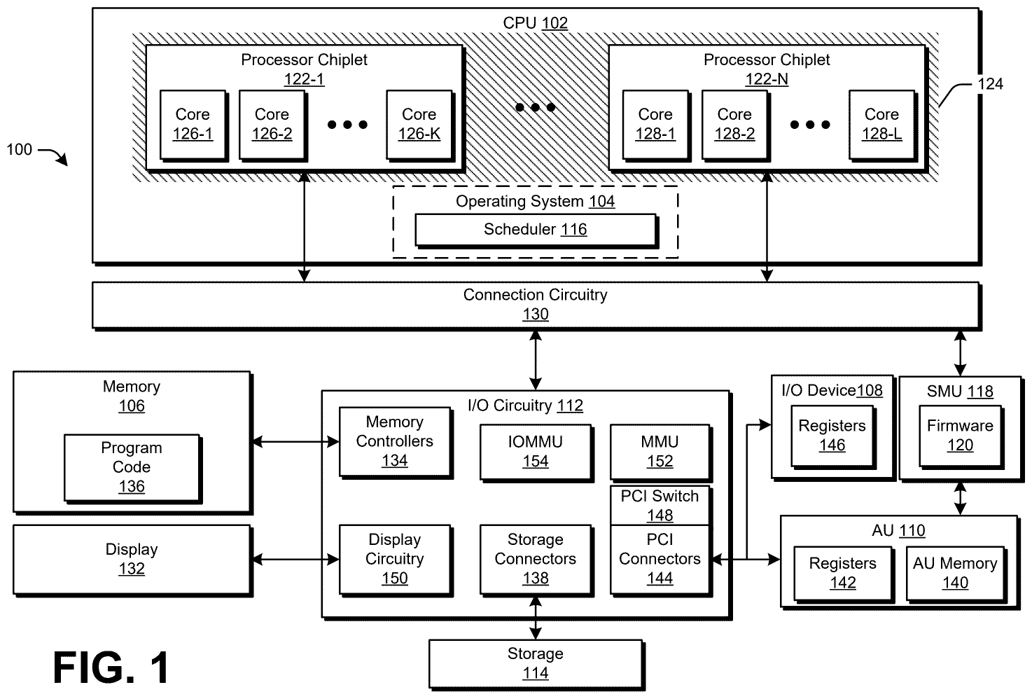

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is an electronic circuit configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, one or more accelerator units (AUs) 110, storage 114) for the execution of tasks for the applications, provide an interface to I/O devices (e.g., I/O device 108) for the applications, or any combination thereof. In particular, the OS 104 includes a scheduler 116 (e.g., implemented in software of the OS 104 kernel) that schedules the execution of tasks (e.g., instructions) for applications, such as by dispatching the tasks among different processing resources of the processing system 100 (e.g., different cores of the CPU 102 and/or different AUs 110) for execution.

In this example, the processing system 100 includes a system management unit (SMU) 118 which is communicatively coupled to the CPU 102 (e.g., via the connection circuitry 130) and the AU 110 via one or more wired or wireless connections. In general, the SMU 118 is an electronic circuit (e.g., a processor or a controller) configured to perform operations related to power, thermal, and hardware management for the processing system 100. To carry out such operations, the SMU 118 includes firmware 120 (e.g., power management firmware), which is executable code or software instructions embedded within (e.g., stored in non-volatile memory of) the SMU 118. Broadly, the SMU 118 (by running the firmware 120) is configured to control power states, adjust voltages and power delivery, monitor temperature sensors, activate cooling mechanisms (e.g., fans), and manage clock frequencies for circuitry components of the processing system 100 such as the CPU 102 (and cores thereof), the AU 110, and the memory 106. In accordance with the described techniques, the SMU 118 (by running the firmware 120) is configured to update a task scheduling policy implemented by the scheduler 116 based on a detected utilization of the processing system 100, e.g., utilization of the CPU 102 and the AUs 110.

Here, the SMU 118 and the firmware 120 are implemented as separate components of the processing system 100. In variations, however, the SMU 118 and/or the firmware 120 are included in and/or implemented by one or more different components of the processing system 100, such as the CPU 102, the memory 106, the I/O device 108, the AU 110, the I/O circuitry 112, the storage 114, and so forth. In at least one implementation, the SMU 118 and the firmware 120 or portions of the SMU 118 and the firmware 120 are included in at least two of the depicted components of the processing system 100. By way of example, the SMU 118 and the firmware 120 may be included in or otherwise implemented by at least the CPU 102, the AU 110, and the I/O circuitry 112.

The CPU 102 includes one or more processor chiplets 122, which are communicatively coupled together by a data fabric 124 in one or more implementations. Each of the processor chiplets 122, for example, includes one or more processor cores 126, 128 configured to concurrently execute one or more series of instructions, also referred to herein as “threads,” for an application. Further, the data fabric 124 communicatively couples each processor chiplet 122-N of the CPU 102 such that each processor core (e.g., processor cores 126) of a first processor chiplet (e.g., 116-1) is communicatively coupled to each processor core (e.g., processor cores 128) of one or more other processor chiplets 122. Though the example embodiment presented in FIG. 1 shows a first processor chiplet (122-1) having three processor cores (126-1, 126-2, 126-K) representing a K number of processor cores 126 and a second processor chiplet (122-N) having three processor cores (e.g., 128-1, 128-2, 128-L) representing an L number of processor cores 128, in other implementations (L being an integer number greater than or equal to one), each processor chiplet 122 may have any number of processor cores 126, 128. For example, each processor chiplet 122 can have the same number of processor cores 126, 128 as one or more other processor chiplets 122, a different number of processor cores 126, 128 as one or more other processor chiplets 122, or both. Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 130. For example, each processor chiplet 122 of the CPU 102 is communicatively coupled to the I/O circuitry 112 by the connection circuitry 130. In addition, the SMU 118 is communicatively coupled to the CPU 102 by the connection circuitry 130. The connection circuitry 130 includes, for example, one or more data fabrics, buses, buffers, queues, and the like. The I/O circuitry 112 is configured to facilitate communications between two or more components of the processing system 100 such as between the CPU 102, system memory 106, display 132, universal serial bus (USB) devices, peripheral component interconnect (PCI) devices (e.g., I/O device 108, AU 110), storage 114, the SMU 118, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 134. These memory controllers 134, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 134 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 136 (e.g., an executable file) associated with the application from, for example, a storage 114 into system memory 106. This storage 114, for example, includes a non-volatile storage such as a flash memory, solid-state memory, hard disk, optical disc, or the like configured to store program code 136 for one or more applications.

To facilitate communication between the storage 114 and other components of processing system 100, the I/O circuitry 112 includes one or more storage connectors 138 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), video encoding/decoding processors, video processing engines (VPEs), display rendering processors, non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 140. This AU memory 140, for example, includes any combination of one or more volatile memories and/or non-volatile memories, examples of which include caches, video RAM (VRAM), or the like. In one or more implementations, these compute units are also configured to execute these threads based on the data stored in one or more physical registers 142 of the AU 110.

To facilitate communication between the AU 110 and one or more other components of processing system 100, the I/O circuitry 112 includes or is otherwise connected to one or more connectors, such as PCI connectors 144 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 144 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 146 of the I/O device 108. In one or more implementations, such physical registers 146 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 144, and one or more other components of the processing system 100, the I/O circuitry 112 includes PCI switch 148. The PCI switch 148, for example, includes circuitry configured to route packets to and from the components of the processing system 100 connected to the PCI connectors 144 as well as to the other components of the processing system 100. As an example, based on address data indicated in a packet received from a first component (e.g., CPU 102), the PCI switch 148 routes the packet to a corresponding component (e.g., AU 110) connected to the PCI connectors 144.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 132, or both. The display 132, for example, includes a cathode-ray tube (CRT) display, liquid crystal display (LCD), light emitting diode (LED) display, organic light emitting diode (OLED) display, or any combination thereof. To enable the processing system 100 to display a scene on the display 132, the I/O circuitry 112 includes display circuitry 150. The display circuitry 150, for example, includes high-definition multimedia interface (HDMI) connectors, DisplayPort connectors, digital visual interface (DVI) connectors, USB connectors, and the like, each including circuitry configured to communicatively couple the display 132 to the I/O circuitry 112. Additionally or alternatively, the display circuitry 150 includes circuitry configured to manage the display of one or more scenes on the display 132 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 152 and input-output memory management unit (IOMMU) 154. The MMU 152 includes, for example, circuitry configured to manage memory requests, such as from the CPU 102 to the system memory 106. For example, the MMU 152 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 152 is configured to translate the virtual address indicated in the memory request to a physical address in the system memory 106 and to fulfill the request.

The IOMMU 154 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 146 of the I/O device 108, the registers 142 of the AU 110, and/or the AU memory 140, the CPU 102 issues one or more MMIO requests. MMIO requests each request access to read, write, fetch, or pre-fetch data residing at one or more virtual addresses (e.g., guest virtual addresses) which each represent at least a portion of the registers 146 of the I/O device 108, the registers 142 of the AU 110, or the AU memory 140, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 154 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

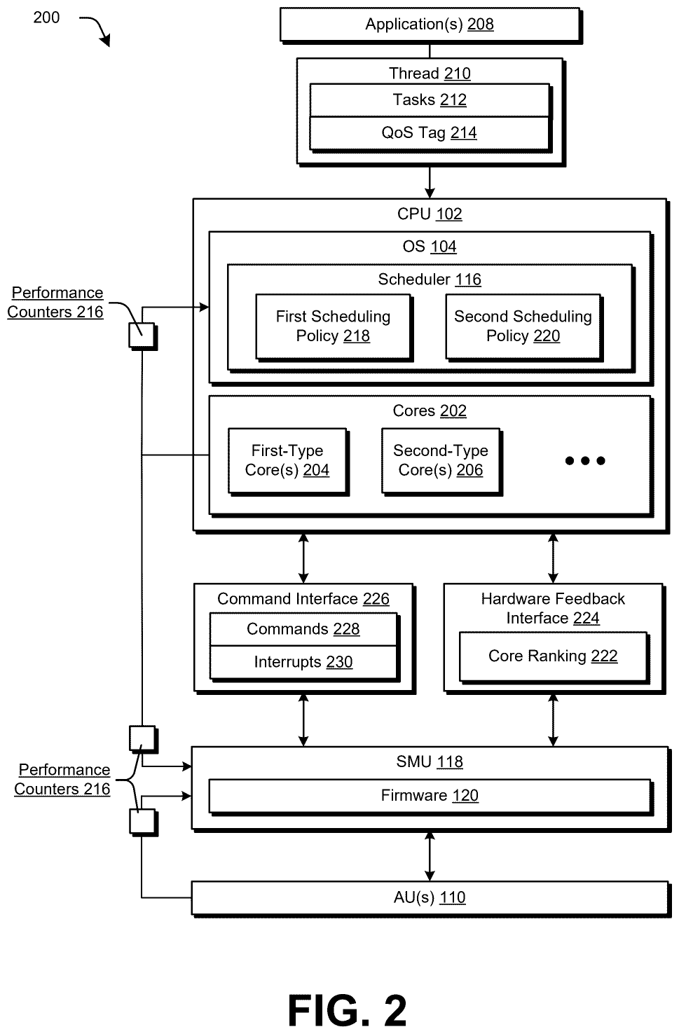

FIG. 2 is a block diagram of a non-limiting example system 200 to implement techniques of hybrid scheduling for heterogeneous processor systems. The system 200 includes the CPU 102 running the OS 104 and the scheduler 116, the SMU 118 running the firmware 120, and one or more AUs 110, as depicted and described above with reference to FIG. 1. In accordance with the described techniques, the CPU 102, the SMU 118, and the one or more AUs 110 are coupled to one another via one or more wired and/or wireless connections. Example wired connections include, but are not limited to, buses (e.g., a data bus), interconnects, traces, and planes.

Here, the CPU 102 includes a plurality of cores 202 of different types, e.g., the CPU 102 is a heterogenous core processor. By way of example, the cores 202 include one or more first-type cores 204 and one or more second-type cores 206. Generally, the different core types implemented by the CPU 102 exhibit increased power efficiencies at different clock frequencies. Notably, power efficiency of a processor or processor core is a ratio of performance (e.g., measured in instructions executed per second) to power consumption, e.g., measured in watts. Power efficiency can be expressed mathematically as

$$Power Efficiency = \frac{Performance}{Power Consumption} .$$

Clock frequency, as applied to a processor or processor core, is the number of processing cycles that the processor or processor core executes per second, e.g., measured in hertz (Hz).

Here, the first-type core 204 exhibits increased power efficiency relative to the second-type core 206 at a reduced clock frequency. For example, the first-type core 204 exhibits increased power efficiency relative to the second-type core 206 at clock frequencies between zero and three GHz, while the second-type core 206 exhibits increased power efficiency relative to the first-type core 204 at clock frequencies that are above three GHz. That is, the first-type cores 204 are more energy efficient than the second-type cores 206 since executing threads or tasks on the first-type cores 204 at the reduced clock frequency reduces power consumption for the system. In contrast, the second-type cores 206 are considered more performant than the first-type cores 204 since executing tasks or threads on the second-type cores 206 at the increased clock frequency increases the speed at which the tasks or threads are executed. In various examples performance of a core 202 is measured in instructions executed per processor cycle (e.g., IPC), and the maximum IPC achievable by the second-type core 206 is greater than the maximum IPC achievable by the first-type core 204. Although two core types of the CPU 102 are depicted and described herein, it is to be appreciated that the cores 202 include three or more types of cores each exhibiting increased power efficiencies at different ranges of clock frequencies.

The AUs 110 are specialized processors implemented in electronic circuitry to execute certain tasks and/or workloads with increased computational efficiency relative to the CPU 102. By way of example, the AUs 110 include a GPU configured to execute graphics processing tasks faster than the CPU 102, an NPU and/or an inference processor configured to execute machine learning and/or artificial intelligence workloads faster than the CPU 102, a VPE and/or video encoding/decoding processor configured to execute video processing (e.g., encoding and decoding) workloads faster than the CPU 102, and/or display rendering processors configured to render display data and/or manage display outputs faster than the CPU 102.

In other words, the system 200 is representative of a heterogeneous processor system including a plurality of different processor types (e.g., the CPU 102 and the AUs 110) and different core types, e.g., the first-type cores 204 and the second-type cores 206 of the CPU 102. In accordance with this heterogeneous processor configuration, the scheduler 116 is configured to schedule tasks for execution by the most suitable processor and/or core type. In one example, this includes dispatching specialized workloads for execution by corresponding AUs 110 (e.g., dispatching machine learning workloads for execution by NPUs and/or inference processors) to speed up execution of the specialized workloads. Additionally or alternatively, the scheduler 116 dispatches high priority tasks for execution by the second-type cores 206 (e.g., which can execute more instructions per cycle than the first-type cores 204) to speed up execution of the high priority tasks. In yet another non-limiting example, the scheduler 116 dispatches low priority tasks for execution by the first-type cores 204 to reduce power consumption for the system 200.

As previously mentioned, the OS 104 is configured to manage execution of one or more applications 208. As part of this, the applications 208 submit threads 210 of tasks 212 to be executed by the CPU 102 and/or the AUs 110. Here, tasks 212 are software instructions executable by one or more processors or processor cores. Further, threads 210 are series or sequences of tasks 212 (e.g., software instructions) that are executable by one or more processors or processor cores. In various examples, the applications 208 implements multithreading, which is the ability of an application 208 to submit multiple threads that are executable concurrently on different processors (e.g., the CPU 102 and/or the AUs 110) or different processor cores (e.g., the cores 202). Multithreading enables parallel computing of multiple threads, which speeds up execution of the application 208.

As shown, the threads 210 are marked with Quality of Service (QOS) tags 214. By way of example, an application 208 marks a thread 210 with a QoS tag 214 indicative of a priority for scheduling the thread 210. In a specific but non-limiting example, threads 210 are markable with “high priority,” “medium priority,” and “low priority” QoS tags 214. In this example, the high priority threads 210 are allocated more hardware (e.g., processing, memory, and communication) resources, and/or are scheduled for more immediate execution as compared to medium and low priority threads 210. Further, low priority threads 210 are allocated less hardware (e.g., processing, memory, and communication) resources, and/or are delayed to give preference to high and medium priority threads 210. Moreover, medium priority threads are allocated more hardware resources than low priority threads but less hardware resources than high priority threads. Additionally or alternatively, medium priority threads 210 are delayed to give preference to high priority threads 210, but are scheduled for more immediate execution as compared to low priority threads 210.

Hardware resources expected to be invoked (e.g., processing, memory, communication, and I/O resources) by a thread 210 impact the thread's QoS tag 214. For example, a degree to which a thread 210 is compute-bound, memory-bound, I/O bound, and communication-bound impacts the thread's QoS tag 214. Additionally or alternatively, the context in which the thread 210 is running impacts the thread's QoS tag 214. By way of example, the threads 210 running the following processes are associated with progressively higher priority QoS tags: (1) background processes (e.g., data indexing and OS 104 updates), (2) user-initiated processes triggered by user input (e.g., opening a file), (3) user-interactive processes (e.g., displaying a user interface with which the user is actively engaging).

As part of managing execution of the applications 208, the OS 104 includes the scheduler 116 that schedules the threads 210 for execution by different processing resources, e.g., the cores 202 and/or the AUs 110. As part of this, the scheduler 116 receives a thread 210 and determines which core 202 or which AU 110 to execute the thread 210. Further, the scheduler 116 dispatches the thread 210 to the determined core 202 or the determined AU 110 for execution. As discussed herein, operations performed by the OS 104 or the scheduler 116 are operations performed by the CPU 102 by running the OS 104 or the scheduler 116.

As previously mentioned, the SMU 118 (by running the firmware 120) is configured to perform operations related to power and thermal management of system circuitry components. As part of its power and thermal management functionality, the firmware 120 is configured to receive performance counters 216 from each of the cores 202 and each of the AUs 110. For example, each core 202 and each AU 110 maintains performance counters 216 (e.g., within hardware registers) that track performance metrics associated with respective cores 202 and respective AUs 110. Periodically (e.g., every millisecond), the cores 202 and the AUs 110 update the performance counters 216, and the firmware 120 reads the updated performance counters 216. Examples of performance metrics tracked by the performance counters 216 include a total number of instructions executed during a certain time period and IPC. Notably, operations described herein as performed by the firmware 120, are operations performed by the SMU 118 by running the firmware 120.

Based on the performance counters 216, the firmware 120 calculates the utilization of the cores 202 and the AUs 110. Taking IPC as an example performance metric conveyable by the performance counters 216, the firmware 120 includes indications of maximum IPCs achievable by individual processing resources, e.g., individual cores 202 and AUs 110. Given this, the firmware 120 receives a performance counter 216 indicative of an actual IPC currently implemented by a processing resource (e.g., a core 202 or AU 110), and the firmware 120 calculates the utilization of the processing resource using the actual IPC and the maximum IPC based on the following relationship:

$$Utilization = \frac{Actual IPC}{Maximum IPC} .$$

This process is repeated for each processing resource to determine the utilization of each individual core 202 and each individual AU 110. More generally, the utilization of a processing resource is the percentage of total processing capability of the processing resource that is currently being utilized.

As shown, the scheduler 116 includes a first scheduling policy 218 and a second scheduling policy 220. Broadly, a scheduling policy includes or corresponds to a set of rules, instructions, and/or criteria defining when and how threads 210 are scheduled for execution. In accordance with the first scheduling policy 218, the scheduler 116 schedules threads 210 based on the QoS tags 214, utilization of the cores 202, and one or more operating conditions of the system 200. By way of example, the OS 104 also receives the performance counters 216 from the cores 202 (but not the AUs 110), and the OS 104 calculates the utilization of the cores 202 in a similar manner to the firmware 120. Examples of the operating conditions include a user-tunable parameter that specifies a balance between competing scheduling preferences for the OS 104, such as application responsiveness vs. throughput, power efficiency vs. performance, and the like, e.g., also referred to as a “slider position.” Additional examples of the operating conditions include remaining battery life and whether the device is connected to an external power source (e.g., receiving alternating current (AC) power from an outlet) or an internal power source, e.g., receiving direct current (DC) power from an internal battery.

In accordance with the first scheduling policy 218, the scheduler 116 generally schedules threads 210 with higher priority QoS tags 214 for execution by the second-type cores 206. By doing so, the second-type cores 206 can be run at increased clock frequencies (e.g., at which the second-type cores 206 are more power efficient) to take advantage of the increased IPC achievable by the second-type core 206, which increases the speed at which the high priority threads 210 are executed. In addition, the scheduler 116 generally schedules threads 210 with lower priority QoS tags 214 for execution by the first-type cores 202. By doing so, the first-type cores 204 can be run at reduced clock frequencies (e.g., at which the first-type cores 204 are more power efficient), thereby reducing power consumption for the system 200.

The operating conditions and utilization of the cores 202 also impact task scheduling in accordance with the first scheduling policy 218. In various examples, the scheduler 116 prioritizes dispatching threads to cores 202 having lower levels of utilization. Additionally or alternatively, the scheduler 116 prioritizes dispatching threads 210 to first-type cores 204 when the remaining battery life is low, the device is not connected to an external AC power source, the user-tunable parameter specifies a preference of power efficiency over performance, and so on. Contrarily, the scheduler 116 prioritizes dispatching threads 210 to second-type cores 206 when battery life is high and/or the device is connected to an external AC power source, the user-tunable parameter specifies a preference of performance over power efficiency, and so on.

In accordance with the second scheduling policy 220, the scheduler 116 is configured to schedule the threads 210 based on a core ranking 222 of the cores 202 generated by the firmware 120. Unlike the OS 104, the firmware 120 receives the performance counters 216 of the AUs 110 in addition to the performance counters 216 of the cores 202, and therefore, the utilization of the cores 202 and the AUs 110 is available to the firmware 120. Based on the utilization of the cores 202 and the AUs, the firmware 120 detects a utilization scenario of the system 200 in which to override the first scheduling policy 218 in order for the firmware 120 to control task/thread scheduling.

In various examples, this utilization scenario is a scenario in which the utilization of the cores 202 is below a core utilization threshold, and the utilization of one or more of the AUs 110 is above an AU utilization threshold. This utilization scenario is indicative of a specialized workload being executed by one or more AUs 110 designed to execute the specialized workloads, e.g., the system 200 is executing a machine learning workload on one or more NPUs and/or inference processors. During the execution of these workloads, it is preferable for the threads 210 that are executing on the cores 202 of the CPU 102 be executed on the first-type cores 204 at the reduced clock frequency in order to reduce power consumption for the system 200. This is because, while the primary, specialized workload is running on one or more AUs 110, the threads 210 that are running on the CPU 102 are secondary and/or lower priority processes. However, QoS tagging schemes often inaccurately mark threads 210 with high or medium priority QoS tags 214 during execution of these workloads, leading to the threads 210 being executed on the second-type cores 206. Given the inaccuracy of QoS tagging schemes as well as the inability of the OS 104 to detect the utilization of the AUs 110, the firmware 120 is configured to initiate an update to cause the scheduler 116 to switch to the second scheduling policy 220.

To do so, the firmware 120 generates the core ranking 222 based on the detected utilization scenario. When the utilization scenario is indicative of a high degree of AU 110 utilization (e.g., that exceeds the AU utilization threshold) and a low degree of CPU core 202 utilization (e.g., that falls below the core utilization threshold), for instance, the first-type cores 204 are ranked higher than the second-type cores 206 in the core ranking 222. Furthermore, the firmware 120 writes the core ranking 222 to a hardware feedback interface 224, which is a system that provides feedback to the OS 104 and/or scheduler 116 for use in making thread/task scheduling decisions. In one or more implementations, the hardware feedback interface 224 includes registers or memory locations accessible by the OS 104. Given this, the firmware 120 writes the core ranking 222 to the registers or memory locations (e.g., via data buses or communication channels) and the OS 104 reads the core ranking 222 from the registers or memory locations, e.g., via data buses or communication channels. In one or more examples, the registers or memory locations include a data structure (e.g., a core ranking table) to which the core ranking 222 is written.

In accordance with the second scheduling policy 220, the scheduler 116 schedules threads 210 and/or tasks 212 based on the core ranking 222, e.g., by prioritizing dispatching the threads 210 and/or tasks 212 to first-type cores 204 which are ranked higher in the core ranking 222. In one or more implementations, the scheduler 116 does not rely on the QoS tags 214 when making scheduling decisions in using the second scheduling policy 220. In other words, the firmware 120 controls task/thread scheduling via the core ranking 222 provided by the hardware feedback interface 224 in accordance with the second scheduling policy 220.

In various implementations, the firmware 120 is configured to initiate updates and/or changes to the scheduling policy of the scheduler 116 between the first scheduling policy 218 and the second scheduling policy 220. To do so, the system includes a command interface 226, which is an interface enabling the OS 104 to communicate directly with the firmware 120. In one specific but non-limiting example, the command interface 226 is a platform communications channel (PCC), as described in the Advanced Configuration and Power Interface (ACPI) Specification which is hereby incorporated by reference. In particular, the ACPI specification describes a Type 4 Slave Subspace, which is used by the platform to send asynchronous notifications to the OS 104 for Operating System Power Management (OSPM) tasks. Here, the command interface 226 is implemented as a Type 4 Slave Subspace of a PCC, and the command interface 226 is used by the firmware 120 to send commands 228 and interrupts 230 to the OS 104 for the purpose of directing the OS 104 and scheduler 116 to transition between the first scheduling policy 218 and the second scheduling policy 220.

In response to detecting the utilization scenario in which to override the first scheduling policy 218 and enable the firmware 120 to control thread/task scheduling, the firmware 120 writes a command 228 of a first command type to the command interface 226. The first command type instructs the OS 104 and scheduler 116 to transition from the first scheduling policy 218 to the second scheduling policy 220. After having written the core ranking 222 to the hardware feedback interface 224, the firmware 120 additionally raises an interrupt 230 via the command interface 226. Broadly, the interrupt 230 is a flag or other indication conveying that a command 228 has been written to the command interface 226 and is ready to be executed by the OS 104. Thus, responsive to the interrupt 230 being raised, the OS 104 reads the first command type from the command interface 226, reads the core ranking 222 from the hardware feedback interface 224, and the scheduler 116 transitions to the second scheduling policy 220 to schedule threads 210 in accordance with the core ranking 222.

In response to detecting a usage scenario in which to transition back to the first scheduling policy 218 and relinquish control by the firmware 120 to influence thread/task scheduling, the firmware 120 writes a command 228 of a second command type to the command interface 226. The second command type instructs the OS 104 and scheduler 116 to transition from the second scheduling policy 220 to the first scheduling policy 218. In addition, the firmware raises an interrupt 230 via the command interface 226. Responsive to the interrupt 230 being raised, the OS 104 reads the second command type and the scheduler 116 transitions to the first scheduling policy 218, in part, by no longer relying on the core ranking 222 for making scheduling decisions. Regardless of the scheduling policy 218, 220, the scheduler 116 dispatches threads 210 to the AUs 110 based on the threads 210 having been designated (e.g., marked) by the applications 208 for execution by the AUs 110.

Here, unlike conventional scheduling techniques, the described techniques relate to a hybrid scheduling paradigm in which the OS 104 and the scheduler 116 transition between a first scheduling policy 218 and a second scheduling policy 220 based on utilization of the cores 202 and the AUs 110. While the first scheduling policy 218 has the advantage of scheduling threads 210 based on software thread-level processing demands using the QoS tags 214, the first scheduling policy 218 does not account for the utilization of the AUs 110. Moreover, while the second scheduling policy 220 has the advantage of scheduling threads 210 based on the utilization of the platform as a whole (e.g., including the cores 202 and the AUs 110), the second scheduling policy 220 does not account for the software thread-level processing demands. Due to this, the first and second scheduling policies 218, 220 are more effective in different usage scenarios.

Indeed, one goal of task scheduling in a heterogeneous processor system is to reduce power consumption by running lower priority threads 210 on the more energy efficient first-type cores 204 and increasing performance and system responsiveness for higher priority threads 210 by running such threads 210 on the more performant second-type cores 206. In most scenarios, the first scheduling policy 218 outperforms the second scheduling policy 220 in terms of achieving this goal due to the scheduling decisions being made on the basis of the thread-level processing demands specified by the QoS tags 214. However, in certain specific scenarios such as the aforementioned utilization scenario in which the utilization of the AUs 110 exceeds the utilization of the cores 202, the second scheduling policy 220 outperforms the first scheduling policy in terms of achieving the goal. This is because, due to the reliance on the QoS tags 214 and the unawareness of the AU 110 utilization, the first scheduling policy 218 inaccurately schedules threads 210 for execution on the second-type cores 206 despite the threads 210 running processes that are secondary to the primary process that is running on the AUs 110, Here, the described techniques implement a hybrid scheduling approach to transition between the scheduling policies 218, 220 in order to implement the optimal scheduling policy for the utilization scenario. By doing so, the described techniques reduce power consumption for the system 200 while improving or maintaining performance of higher priority threads 210, as compared to conventional single policy scheduling techniques.

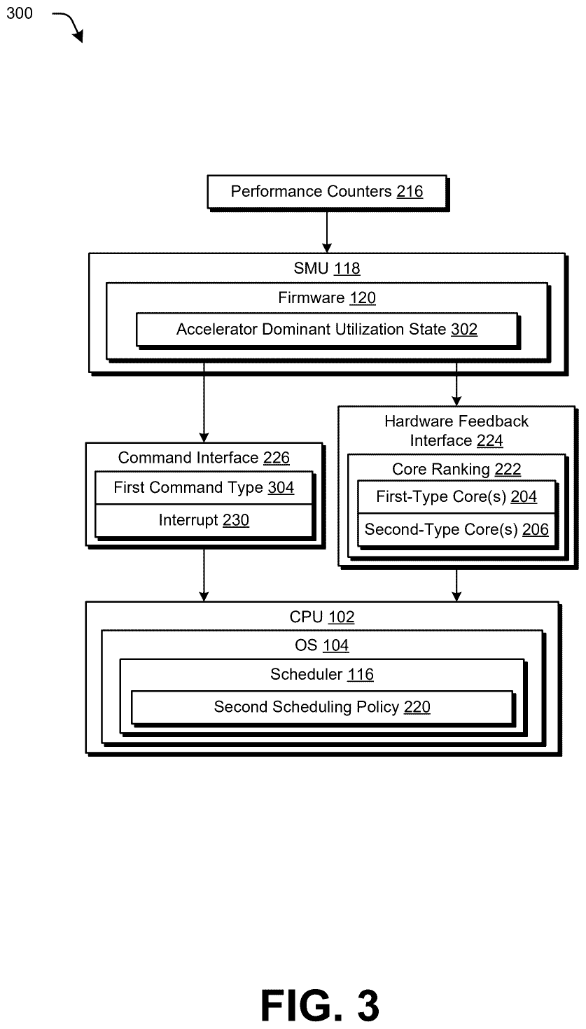

FIG. 3 depicts a block diagram of a non-limiting example system 300 to transition from a first scheduling policy to a second scheduling policy. Here, the firmware 120 receives the performance counters 216 from the cores 202 and the AUs 110. In particular, the firmware 120 reads the performance counters 216 from hardware registers of the cores 202 and the AUs 110. Based on the performance counters 216, the firmware 120 calculates a utilization of each individual core 202 and/or each individual AU 110 in accordance with the described techniques. Furthermore, the firmware 120 detects an accelerator dominant utilization state 302 based on the calculated utilizations.

More specifically, the firmware 120 detects an accelerator dominant utilization state 302 based on the utilization of the cores 202 falling below a core utilization threshold and/or the utilization of one or more AUs 110 exceeding an AU utilization threshold, e.g., which can be the same or different for different types of AUs 110. The utilization of the cores 202 is a function of the number of cores 202 that are being utilized as well as the degree of utilization calculated for the individual cores. In one or more implementations, the utilization of one or more NPUs and/or inference processors exceeds a threshold utilization, and as such, the accelerator dominant utilization state 302 is indicative of a machine learning workload running on the processor system. Additionally or alternatively, the utilization of one or more VPEs, video encoding/decoding processors, and/or display rendering processors exceeds a utilization threshold, e.g., the accelerator dominant utilization state is indicative of a video conferencing workload running on the processor system. Notably, the thresholds defining the accelerator dominant utilization state 302 are programmed as part of the firmware 120 in various implementations.

Notably, utilization of processors and processor cores is also a measure of memory-boundedness and compute-boundedness of the workload that is running on the cores 202. For example, higher degrees of processor or core utilization are indicative of higher degrees of compute boundedness, while lower degrees of processor or core utilization are indicative of higher degrees of memory boundedness. Thus, the accelerator dominant utilization state 302 is also conceptualizable as a workload that is compute-bound on the AU 110 but not compute-bound (e.g., memory-bound) on the CPU 102.

Responsive to detecting the accelerator dominant utilization state 302, the firmware 120 generates the core ranking 222 and writes the core ranking 222 to the hardware feedback interface 224. When the accelerator dominant utilization state 302 is detected, the first-type cores 204 are ranked higher than the second-type cores 206 as shown, thereby directing the OS 104 to prioritize dispatching threads 210 for execution by the first-type cores 204 over the second-type cores 206. Also responsive to detecting the accelerator dominant utilization state 302, the firmware 120 writes a command 228 of a first command type 304 to the command interface 226. The command 228 of the first command type 304 is an instruction directing the OS 104 and the scheduler 116 to switch from implementing the first scheduling policy 218 to implementing the second scheduling policy 220. In other words, the command 228 of the first command type 304 is an instruction to begin using feedback and/or hints provided by the firmware 120 via the core ranking 222 in making scheduling decisions. After the first command type 304 is written to the command interface 226 and the core ranking 222 is written to the hardware feedback interface 224, the firmware 120 raises an interrupt 230 via the command interface 226.

Responsive to the interrupt 230 being raised, the OS 104 reads the first command type 304 from the command interface 226. Based on the first command type 304, the OS 104 reads the core ranking 222 from the hardware feedback interface 224. Although not shown, the OS 104 stores a copy of the core ranking 222 in a memory resource (e.g., a cache system or hardware registers) of the CPU 102 in various implementations. By doing so, the OS 104 and/or the scheduler 116 can access the core ranking 222 from the CPU memory resource, which is faster than accessing the core ranking 222 from the hardware feedback interface 224.

Based on the first command type 304, the scheduler 116 transitions from the first scheduling policy 218 to the second scheduling policy 220, as shown. As part of this, the firmware 120 controls task/thread scheduling via the core ranking 222. For instance, the scheduler 116 ceases to use the QoS tags 214, the operating conditions, and the core 202 utilization when making scheduling decision, and begins using the core ranking table to schedule threads 210. In accordance with the second scheduling policy 220, for instance, the scheduler 116 prioritizes scheduling threads 210 for execution by the first-type cores 204 over the second-type cores 206 based on the core ranking 222. As part of this, the scheduler 116 migrates currently executing threads 210 from the second-type cores 206 to the first-type cores 204, and the scheduler 116 dispatches newly received threads 210 for execution by the first-type cores 204 (if available) rather than the second-type core 206. In various scenarios, implementation of the second scheduling policy 220 involves dispatching threads 210 that are marked with high priority QoS tags 214 for execution by the first-type (e.g., energy efficient) cores 206.

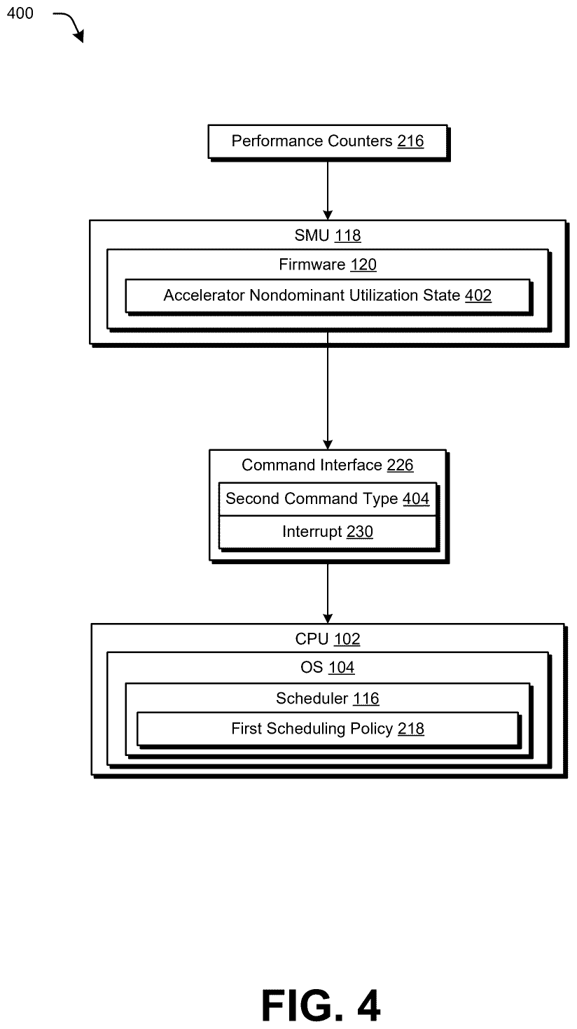

FIG. 4 depicts a block diagram of a non-limiting example system 400 to transition from a second scheduling policy to a first scheduling policy. Here, the firmware 120 receives the performance counters 216 from the cores 202 and the AUs 110. In particular, the firmware 120 reads the performance counters 216 from hardware registers of the cores 202 and the AUs 110. Based on the performance counters 216, the firmware 120 calculates a utilization of each individual core 202 and/or each individual AU 110 in accordance with the described techniques. Furthermore, the firmware 120 detects an accelerator nondominant utilization state 402 based on the calculated utilizations. In particular, the firmware 120 detects the accelerator nondominant utilization state 402 based on the utilization of the of the cores 202 exceeding the core utilization threshold, and/or the utilization of one or more AUs 110 falling below the AU utilization threshold.

Responsive to detecting the accelerator nondominant utilization state 402, the firmware 120 writes a command 228 of a second command type 404 to the command interface 226. The command 228 of the second command type 404 is an instruction directing the OS 104 and the scheduler 116 to switch from implementing the second scheduling policy 220 to implementing the first scheduling policy 218. In other words, the command 228 of the second command type 404 is an instruction to cease using feedback and/or hints provided by the firmware 120 via the core ranking 222 in making scheduling decisions. After the second command type 404 is written to the command interface 226, the firmware 120 raises an interrupt 230 via the command interface 226.

Responsive to the interrupt 230 being raised, the OS 104 reads the second command type 404 from the command interface 226. Based on the second command type 404, the scheduler 116 transitions from the second scheduling policy 220 to the first scheduling policy 218, as shown. As part of this, the firmware 120 relinquishes control of task/thread scheduling via the core ranking 222. For instance, the scheduler 116 ceases to use the core ranking 222 when making scheduling decision, and begins using the QoS tags 214, the operating conditions, and the core 202 utilization to schedule threads 210.

While examples are described herein in which transitions between the first scheduling policy 218 and the second scheduling policy 220 are initiated based on utilization of the cores 202 and the AUs 110, these examples are not to be construed as limiting. Rather, the firmware 120 overrides the first scheduling policy 218 to implement the second scheduling policy 220 in any scenario detectable by the firmware 120 in which the system would benefit from ignoring the QoS tags 214 and using feedback from the firmware 120 (e.g., from the hardware platform) in making scheduling decisions. Examples of these scenarios include power throttling scenarios and scenarios in which there is a high thermal condition (e.g., overheating) or other error conditions, e.g., memory errors and CPU faults.

In one or more implementations, the firmware 120 is configured to initiate a transition to the second scheduling policy 220 responsive to detecting these scenarios. By way of example, the firmware 120 generates a core ranking 222 that ranks the first-type cores 204 higher than the second-type cores 206 and communicates the ranking to the OS 104 and the scheduler 116 using the hardware feedback interface 224 and the command interface 226. As a result, the firmware 120 controls the thread scheduling via the core ranking 222. Responsive to detecting the termination of these scenarios, the firmware 120 also initiates a transition back to the first scheduling policy 218. By way of example, the firmware 120 writes the second command type 404 to the command interface 226 and raises the interrupt 230, which causes the scheduler 116 to schedule threads 210 in accordance with the first scheduling policy 218. In other words, the firmware 120 relinquishes control of thread scheduling responsive to detecting a termination of the aforementioned scenarios.

In addition to or as part of the specific scenarios described above, the firmware 120 is configured to initiate a transitions between the first scheduling policy 218 and the second scheduling policy 220 based on any one or any combination of a variety of factors. These factors include, but are not limited to including, utilization of the cores 202 of the CPU 102, utilization of the AUs 110, compute-boundedness and memory-boundedness of a workload executing on the CPU 102 and/or the AUs 110, a number of threads 210 executing on the CPU 102 and/or the AUs 110, a degree of parallelism exhibited by the threads 210 running on the CPU 102 and/or the AUs 110, a degree of complexity exhibited by the threads 210 running on the CPU and/or the AUs 110, thermal conditions of hardware resources of the processing system 100, whether power throttling conditions are applied to hardware resources of the processing system 100, and various error conditions, such as memory errors and CPU faults.

In various examples, the firmware 120 is configured to update the core ranking 222 while the scheduler 116 is implementing the second scheduling policy 220. In accordance with the described techniques, the firmware 120 determines to update the core ranking 222 based on a detected utilization of the cores 202. By way of example, the firmware 120 detects that the utilization of a highest-ranked core 202 of the core ranking 222 exceeds a threshold, and as such, the firmware 120 determines to reduce the utilization of the core 202. To do so, the firmware 120 generates an updated core ranking 222 that rearranges an ordering of the first-type cores 204 and writes the updated core ranking 222 to the hardware feedback interface 224. Moreover, the firmware 120 writes a command 228 of a third command type to the command interface 226. The third command type instructs the scheduler 116 to continue implementing the second scheduling policy 220 in accordance with the updated core ranking 222. Once the updated core ranking 222 has been written to the hardware feedback interface 224 and the third command type has been written to the command interface 226, the firmware 120 raises an interrupt 230. The interrupt 230 causes the OS 104 to read the third command type from the command interface 226, read the updated core ranking 222 from the hardware feedback interface 224, and continue implementing the second scheduling policy 220 by scheduling threads 210 based on the updated core ranking. In one or more implementations, the OS 104 updates the copy of the core ranking 222 in the CPU 102 memory resource to include the updated core ranking 222.

While the example scenarios involve ranking the first-type cores 204 higher than the second-type cores 206 in the core ranking 222, these examples are not to be construed as limiting. Rather, the firmware 120 ranks the cores 202 in any order depending on the utilization scenario, including ranking the first-type cores 204 higher than the second-type cores 206, ranking the second-type cores 206 higher than the first-type cores 204, and interspersing the first-type cores 204 and the second-type cores 206 within the core ranking 222.

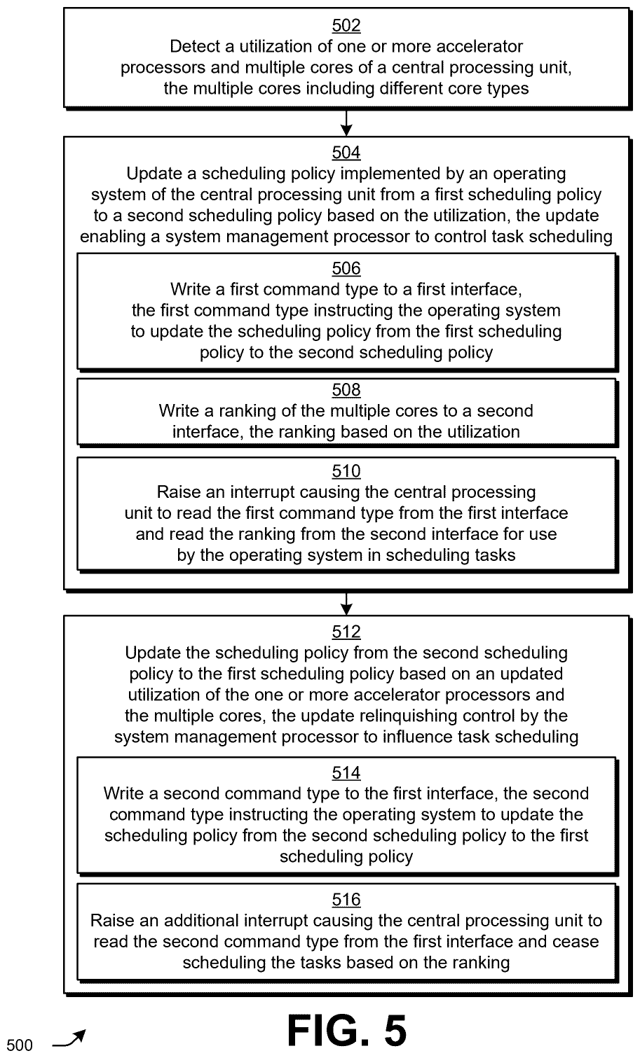

FIG. 5 depicts a procedure 500 in an example implementation of hybrid scheduling for heterogeneous processing systems as implemented by a system management unit. In the procedure 500, a utilization of one or more accelerator processors and multiple cores of a central processing unit is detected, and the multiple cores include different core types (block 502). By way of example, the firmware 120 detects the utilization of one or more AUs and the cores 202 of the CPU 102. Notably, the cores 202 include first-type cores 204 and second-type cores 206, and the first-type cores 202 exhibit increased power efficiency relative to the second-type cores 206 at reduced clock frequencies.

A scheduling policy implemented by an operating system of the central processing unit is updated from a first scheduling policy to the second scheduling policy based on the utilization, and the update enables a system management processor to control task scheduling (block 504). For example, the firmware 120 initiates a transition that causes the scheduler 116 to change from scheduling tasks in accordance with the first scheduling policy 218 to scheduling tasks in accordance with the second scheduling policy 220. The transition is initiated based on the utilization of one or more AUs 110 exceeding an AU utilization threshold, and the utilization of the cores 202 falling below a core utilization threshold, e.g., the accelerator dominant utilization state 302. Broadly, the second scheduling policy 220 enables the firmware 120 to control and/or influence task scheduling.

As part of updating the scheduling policy, a first command type is written to a first interface, and the first command type instructs the operating system to update the scheduling policy from the first scheduling policy to the second scheduling policy (block 506). For instance, the firmware 120 writes a command 228 of the first command type 304 to the command interface 226, and the first command type 304 is an instruction to change from the first scheduling policy 218 to the second scheduling policy 220.

As part of updating the scheduling policy, a ranking of the multiple cores is written to a second interface, and the ranking is based on the utilization (block 508). Based on the detected utilization, for instance, the firmware 120 generates a core ranking 222 which ranks the first-type cores 204 higher than the second-type cores 206. Furthermore, the firmware 120 writes the core ranking 222 to the hardware feedback interface 224.

As part of updating the scheduling policy, an interrupt is raised that causes the central processing unit to read the first command type from the first interface and read the ranking from the second interface for use by the operating system in scheduling tasks (block 510). By way of example, the firmware 120 raises an interrupt 230 via the command interface 226 after having written the first command type 304 and the core ranking 222 to the command interface 226 and the hardware feedback interface 224, respectively. Responsive to the interrupt 230 being raised, the OS 104 reads the first command type 304 from the command interface 226. Furthermore, the OS 104 reads the core ranking 222 from the hardware feedback interface 224 based on the first command type 304. Furthermore, the scheduler 116 implements the second scheduling policy 220 by scheduling threads 210 based on the core ranking 222, while ignoring the QoS tags 214.

The scheduling policy is updated from the second scheduling policy to the first scheduling policy based on an updated utilization of the one or more accelerator processors and the multiple cores, and the update relinquishes control by the system management processor to influence task scheduling (block 512). For example, the firmware 120 detects an updated utilization of the one or more AUs 110 and the cores 202. Here, the utilization of the one or more AUs 110 is below the AU utilization threshold and/or the utilization of the cores 202 is above the core utilization threshold, e.g., the accelerator nondominant utilization state 402. Based on the detected utilization, the firmware 120 initiates a transition that causes the scheduler 116 to change from scheduling tasks in accordance with the second scheduling policy 220 to scheduling tasks in accordance with the first scheduling policy 218. Broadly, task scheduling in accordance with the first scheduling policy 218 is uncontrolled and/or uninfluenced by the firmware 120.

As part of updating the scheduling policy, a second command type is written to the first interface, and the second command type instructs the operating system to update the scheduling policy from the second scheduling policy to the first scheduling policy (block 514). Here, the firmware 120 writes a command 228 of the second command type 404 to the command interface 226, and the second command type 404 is an instruction to change from the second scheduling policy 220 to the first scheduling policy 218.

As part of updating the scheduling policy, an additional interrupt is raised that causes the central processing unit to read the second command type from the first interface and cease scheduling the tasks based on the ranking (block 516). For instance, the firmware 120 raises an interrupt 230 via the command interface 226 after having written the second command type 404 to the command interface 226. Responsive to the interrupt 230 being raised, the OS 104 reads the second command type 404 from the command interface 226. Based on the second command type 404, the scheduler 116 implements the first scheduling policy 218 by scheduling threads 210 based on the QoS tags 214, and no longer scheduling threads 210 based on the core ranking 222.

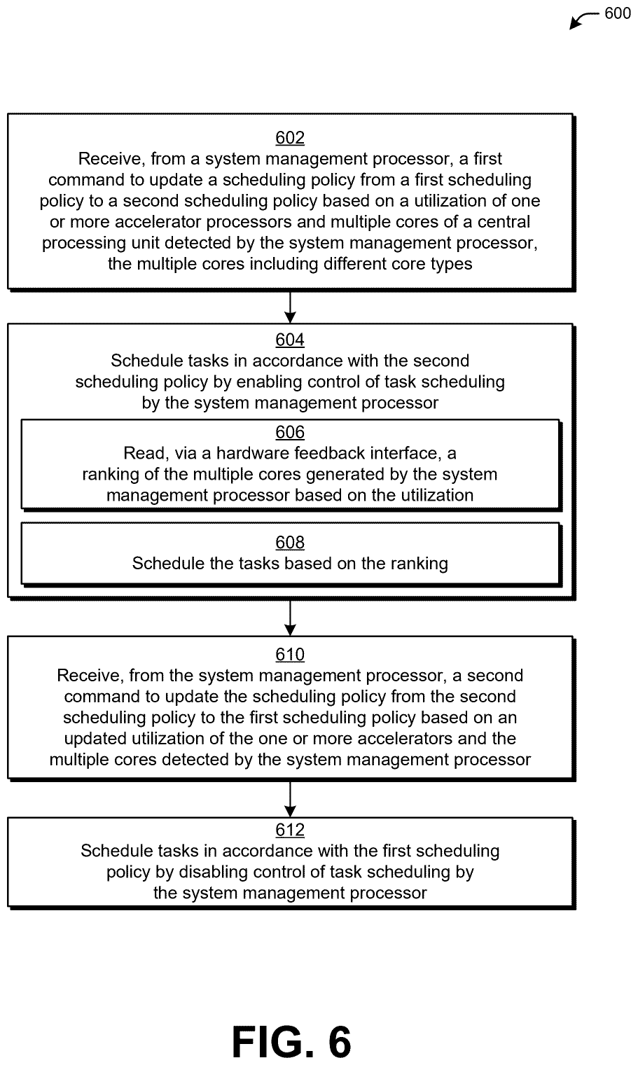

FIG. 6 depicts a procedure 600 in an example implementation of hybrid scheduling for heterogeneous processing systems as implemented by an operating system running on a CPU. In the procedure 600, a first command is received from a system management processor to update a scheduling policy from a first scheduling policy to a second scheduling policy based on a utilization of one or more accelerator processors and multiple cores of a central processing unit detected by the system management processor, and the multiple cores include different core types (block 602). By way of example, the firmware 120 detects the utilization of one or more AUs 110 and the cores 202 (e.g., including the first-type cores 204 and the second-type cores 206) of the CPU 102. In particular, the firmware 120 detects the accelerator dominant utilization state 302. In response, the firmware 120 writes a command 228 of the first command type 304 to the command interface 226 and raises an interrupt 230 via the command interface 226. The OS 104, in response to the interrupt 230 being raised, reads the first command type 304 from the command interface 226. Notably, the first command type 304 is an instruction to transition from scheduling tasks in accordance with the first scheduling policy 218 to scheduling tasks in accordance with the second scheduling policy 220.

Tasks are scheduled in accordance with the second scheduling policy by enabling control of task scheduling by the system management processor (block 604). Based on the first command type 304, the scheduler 116 begins scheduling tasks in accordance with the second scheduling policy 220. Broadly, the second scheduling policy 220 enables the firmware 120 to control and/or influence task scheduling.

As part of implementing the second scheduling policy, a ranking of the cores generated by the system management processor based on the utilization is read via a hardware feedback interface (block 606). For instance, the OS 104 reads the core ranking 222 from the hardware feedback interface 224 based on the first command type 304. Notably, the core ranking 222 is generated by the firmware 120 based on the utilization of the cores 202 and the one or more AUs 110.

As part of implementing the second scheduling policy, tasks are scheduled based on the ranking (block 608). For example, the scheduler 116 implements the second scheduling policy 220 by scheduling threads 210 based on the core ranking 222, while ignoring the QoS tags 214.

A second command is received from the system management processor to update the scheduling policy from the second scheduling policy to the first scheduling policy based on an updated utilization of the one or more accelerators and the multiple cores detected by the system management processor (block 610). Here, the firmware 120 detects an updated utilization of one or more AUs 110 and the cores 202. In particular, the firmware 120 detects the accelerator nondominant utilization state 402. In response, the firmware 120 writes a command 228 of the second command type 404 to the command interface 226 and raises an interrupt 230 via the command interface 226. The OS 104, in response to the interrupt 230 being raised, reads the second command type 404 from the command interface 226. Notably, the second command type 404 is an instruction to transition from scheduling tasks in accordance with the second scheduling policy 220 to scheduling tasks in accordance with the first scheduling policy 218.

Tasks are scheduled in accordance with the first scheduling policy by disabling control of task scheduling by the system management processor (block 612). Based on the second command type 404, the scheduler 116 begins scheduling tasks in accordance with the first scheduling policy 218. Broadly, task scheduling in accordance with the first scheduling policy 218 is uncontrolled and/or uninfluenced by the firmware 120. More specifically, the scheduler 116 implements the first scheduling policy 218 by scheduling threads 210 based on the QoS tags 214, and no longer scheduling threads 210 based on the core ranking 222.

What is claimed is:

1. A system comprising:
a central processing unit having multiple cores of at least two different core types;
one or more accelerator processors; and
a system management processor configured to update a scheduling policy implemented by an operating system of the central processing unit from a first scheduling policy to a second scheduling policy based on utilization of the multiple cores and/or the one or more accelerator processors, wherein the update to the second scheduling policy enables the system management processor to control task scheduling.

2. The system of claim 1, wherein the at least two different core types exhibit different power efficiencies at different clock frequencies.

3. The system of claim 1, wherein the first scheduling policy includes scheduling tasks based on Quality of Service tags associated with the tasks.

4. The system of claim 1, wherein to update the scheduling policy, the system management processor is configured to:
generate a ranking of the multiple cores based on the utilization of the multiple cores and/or the one or more accelerator processors; and
communicate the ranking to the operating system for use in scheduling tasks in accordance with the second scheduling policy.

5. The system of claim 4, wherein the utilization of the multiple cores is below a first threshold and the utilization of the one or more accelerator processors is above a second threshold, and the ranking includes one or more cores of a first core type ranked higher than one or more cores of a second core type, wherein the first core type exhibits increased power efficiency relative to the second core type at a reduced clock frequency.

6. The system of claim 4, wherein to communicate the ranking, the system management processor is configured to:
write the ranking to a first interface;
write a first command type to a second interface, the first command type instructing the operating system to switch from implementing the first scheduling policy to implementing the second scheduling policy; and
raise an interrupt via the second interface causing the central processing unit to read the first command type from the second interface and read the ranking from the first interface for use by the operating system in scheduling the tasks.

7. The system of claim 6, wherein the system management processor is further configured to:
write an updated ranking to the first interface based on an updated utilization of the multiple cores;
write a third command type to the second interface, the third command type instructing the operating system to continue implementing the second scheduling policy in accordance with the updated ranking; and
raise an additional interrupt via the second interface causing the central processing unit to read the third command type from the second interface and read the updated ranking from the first interface for use by the operating system in scheduling the tasks.

8. The system of claim 1, wherein the system management processor is configured to further update the scheduling policy from the second scheduling policy to the first scheduling policy based on an updated utilization of the multiple cores and/or the one or more accelerator processors, wherein the further update to the first scheduling policy relinquishes control by the system management processor to influence the task scheduling.

9. The system of claim 8, wherein the updated utilization of the multiple cores is above a first threshold and the updated utilization of the one or more accelerator processors is below a second threshold.

10. The system of claim 8, wherein to further update the scheduling policy, the system management processor is configured to:
write a second command type to an interface, the second command type instructing the operating system to switch from implementing the second scheduling policy to implementing the first scheduling policy; and
raise an interrupt via the interface causing the central processing unit to read the second command type from the interface.

11. A system management processor configured to:
detect a utilization of one or more accelerator processors and/or multiple cores of a central processing unit, the multiple cores including at least two different core types; and
update a scheduling policy of an operating system from a second scheduling policy to a first scheduling policy based on the utilization, wherein the update to the first scheduling policy relinquishes control by the system management processor to influence task scheduling.

12. The system management processor of claim 11, wherein the at least two different core types exhibit different power efficiencies at different clock frequencies.

13. The system management processor of claim 11, wherein the first scheduling policy includes scheduling tasks based on Quality of Service tags associated with the tasks.

14. The system management processor of claim 11, the second scheduling policy includes scheduling tasks based on a ranking of the multiple cores generated by the system management processor and communicated to the operating system via an interface.

15. The system management processor of claim 11, wherein the utilization of the multiple cores is above a first threshold and the utilization of the one or more accelerator processors is below a second threshold.

16. The system management processor of claim 11, wherein to update the scheduling policy, the system management processor is configured to:
write a second command type to an interface, the second command type instructing the operating system to switch from implementing the second scheduling policy to implementing the first scheduling policy; and
raise an interrupt via the interface causing the central processing unit to read the second command type from the interface.

17. A device comprising:
a system management processor;
one or more accelerator processors; and
a central processing unit having multiple cores of at least two different core types, the central processing unit configured to:
receive, from the system management processor, a command to update a scheduling policy based on utilization of the multiple cores and/or the one or more accelerator processors detected by the system management processor; and
update the scheduling policy by enabling or disabling control of task scheduling by the system management processor based on the utilization.

18. The device of claim 17, wherein the at least two different core types exhibit different power efficiencies at different clock frequencies.

19. The device of claim 17, wherein the utilization of the multiple cores is below a first threshold and the utilization of the one or more accelerator processors is above a second threshold, and to update the scheduling policy, the central processing unit is configured to enable control of the task scheduling by the system management processor.

20. The device of claim 17, wherein the utilization of the multiple cores is above a first threshold and the utilization of the one or more accelerator processors is below a second threshold, and to update the scheduling policy, the central processing unit is configured to disable control of the task scheduling by the system management processor.
